(19) United States
(12) Patent Application Publication
(10) Pub. No.: US 2016/0097708 A1
(43) Pub. Date: Apr. 7, 2016

(54) DRAG SLED AND METHODS OF USING THE SAME

(71) Applicant: Rolin F. Barrett, JR., Raleigh, NC (US)

(72) Inventor: Rolin F. Barrett, JR., Raleigh, NC (US)

(21) Appl. No.: 14/877,395

(22) Filed: Oct. 7, 2015

Related U.S. Application Data
(60) Provisional application No. 62/061,046, filed on Oct. 7, 2014.

(51) Int. Cl. G01N 19/02

(52) U.S. Cl. CPC G01N 19/02

(57) ABSTRACT

A drag sled having a sled body defining a curved front end and a lower surface to which tire samples are removable affixed is disclosed, as are methods of employing the drag sled to calculate coefficient of friction and vehicle speeds. In some embodiments, the tire sample is substantially similar to the tire in question.

### CROSS REFERENCE TO RELATED APPLICATIONS

This application claims priority to U.S. Provisional Patent Application No. 62/061,046, filed Oct. 7, 2014, which is hereby incorporated by reference in its entirety herein.

### TECHNOLOGY FIELD

This disclosure relates generally to drag sleds, particularly those useful to accident reconstructionists to determine the speed of a vehicle based on the length of skid marks.

### BACKGROUND

Surface friction testing enables accurate calculation of vehicle velocity at the time of brake locking based on the skid marks left by the vehicle sliding on the test surface.

Typically, at accident scenes, the length of skid marks are measured by the authorities or even after the fact by accident reconstructionists.

Speed can be estimated based upon the application of the laws of physics. There are various known formulas for calculating the speed of a vehicle based upon the length of the skid marks, and the coefficient of friction of the road surface. Since measuring the physical length of the skid marks is a relatively straightforward exercise, the determination of the coefficient of friction is important.

Several devices and methods for determining the coefficient of friction exist. One of them is the drag sled. Traditionally, the drag sled is a rectangular box with a tire tread permanently mounted on a lower surface. The drag sled is placed, tire side down, on the test surface (preferably at or near the skid marks), and pulled with a scale. Through known calculations, the coefficient of friction of the test surface is calculated. The process is relatively simple. Applicant has found several ways to improve the accuracy, convenience, and workability of the drag sled.

### SUMMARY

Some embodiments provide a drag sled for calculating the coefficient of friction between a tire in question and a test surface, the drag sled comprises a sled body, having a curved front end and defining a lower surface; and a tire sample, having a tread surface, wherein the tire sample is sized and configured to be removably affixed to the lower surface of the sled body such that the tread surface faces the test surface. In some embodiments, the tire sample is removably affixed to the lower surface of the sled body by one or more of hook and loop fasteners, hooks, screws, buttons, and non-permanent glue. In some embodiments, the tire sample is substantially similar to the tire in question. In some embodiments, the tire sample is the same brand and/or model as the tire in question. In some embodiments, the tire sample is derived from the actual tire in question.

Some embodiments provide a kit for evaluating coefficient of friction of a surface, the kit comprising a sled body, having a curved front end and defining a lower surface; and a plurality of tire samples, each sized and configured to be removably affixed to the lower surface of the sled body, and each representing a different model of tire.

Some embodiments provide a method of calculating the speed of a vehicle based upon braking skid marks left by that vehicle, comprising employing a drag sled having a tire sample in contact with a test surface, wherein the tire sample is obtained from substantially the same brand and/or model tire, as the vehicle in question. In some embodiments, the tire sample is derived from the actual tire in question.

These and other embodiments will be apparent in light of the disclosure herein.

### BRIEF DESCRIPTION OF THE DRAWINGS

The foregoing and other aspects of the present invention are best understood from the following detailed description when read in connection with the accompanying drawings. For the purpose of illustrating the invention, there is shown in the drawings embodiments that are presently preferred, it being understood, however, that the invention is not limited to the specific instrumentalities disclosed. Included in the drawings are the following Figures:

FIG. 1 is a side elevational view of an exemplary drag sled in accordance with some embodiments.

FIG. 2 is a plan view of a tire sample removed from the drag sled in accordance with one embodiment.

FIG. 3 is a front elevational view of an exemplary drag sled, with tire sample removed, in accordance with some embodiments.

### DETAILED DESCRIPTION

A drag sled is used in conjunction with a scale to determine the coefficient of friction between two surfaces (for example a tire and a road surface). The drag sled is connected to the scale and the scale is pulled to measure the force necessary to move the sled along the surface. From the known weight of the drag sled (normal force, F_{N}) and the tangential force (F_{T}) measured by the scale, and known formulas the coefficient of friction (a) can be calculated (μ=F_{T}/F_{N}).

Existing drag sleds, as noted above, use a single tire sample, typically having a coefficient of friction, μ, on a bituminous concrete (asphalt) road surface of about 0.75-0.80. Truck tires, not typically included on a drag sled, however, have a coefficient of friction, μ, of about 0.050 to 0.55 on the same surface. Skilled accident investigators recognize the anomaly and employ a correction factor. Because the correction needed is unique to each set of tires and other facts, this correction factor differs from accident to accident, tire to tire, road surface to road surface, and from one investigator to another. The drag sled disclosed herein minimizes the need for a correction factor or the amount of the correction factor. In either case, the introduction of error or variance is diminished. The tire employed in the drag sled disclosed herein can be the exact brand and model tire in question. In some instances, it could be the actual tire from the accident vehicle.

The importance of the accuracy of these calculations cannot be underestimated, not only may insurance payments be affected by the findings of an accident investigator, including the speed of the vehicles in question, but a party to an accident may be subject to or free of criminal charges based on these calculated speeds.

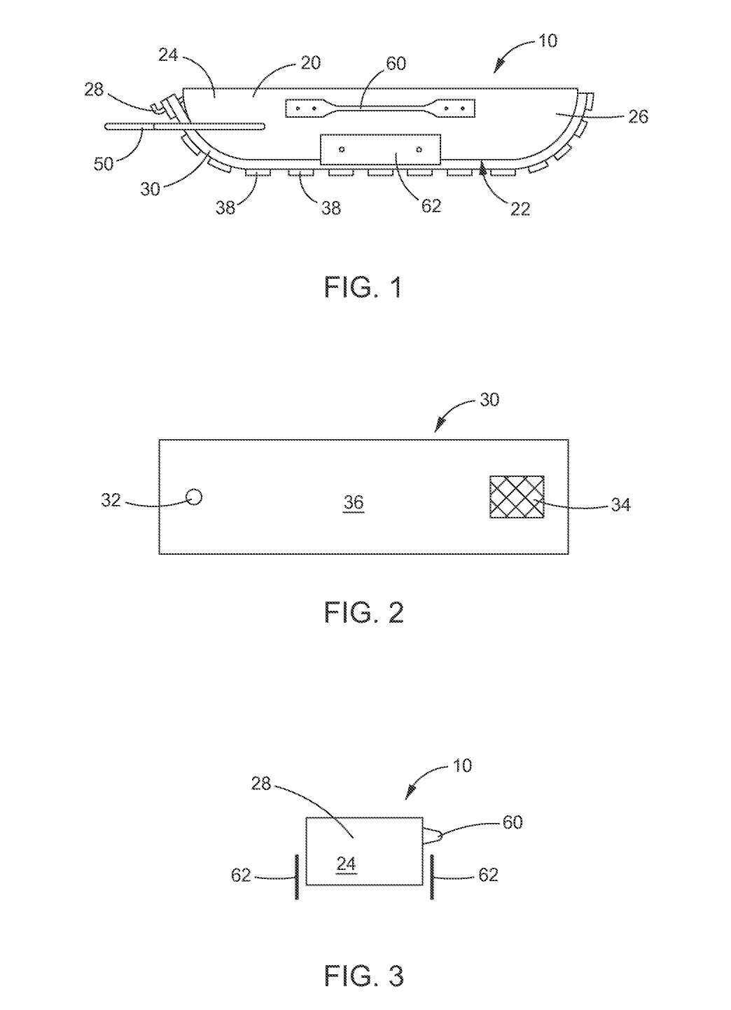

FIG. 1 shows a side view of an exemplary embodiment of a drag sled 10 as contemplated herein. In principle, the drag sled 10 operates similarly to traditional drag sleds. A weighted body 20 is provided, having a roughly rectangular plan view. The body 20 of the drag sled 10 defines a lower surface 22 which is curved at front and rear ends (24, 26), such that the curvature is convex from the perspective of the test surface S. The amount of curvature need not approximate the curvature of a tire, although it may. At one end, the front end 24, a yoke 50 is provided to which a scale (not shown) may be attached to measure the force required to move the drag sled 10. As shown, a carrying handle 60 may be added for convenience. As depicted, a tire sample 30 is removably installed on the lower surface 22 of the drag sled 10.

The curved ends (24, 26), particularly the front curved end 24, reduce the amount of “digging in” which occurs particularly when the test starts. Typically, pulling on a rope attached to the yoke 50 causes a sudden start causing the front end 24 of the sled body 20 to dip, and dig into the road surface. Although the digging in may not be perceptible to the naked eye, particularly on hard surfaces, it occurs nonetheless, and can affect the reading. The effect can also be minimized by pulling the yoke 50 in a direction parallel to the road surface. Positioning of the yoke 50 facilitates this type of arrangement.

The tire sample 30 can be made from any source. Although it is contemplated that tire manufacturers could supply a tire sample 30 of their various tires to investigators, it is not necessary. A standard tire can be purchased and cut to size and affixed to the lower surface 22 of the sled body 20. In this manner, investigators can locate and test the actual brand of tire at the actual accident location. In some instances, the investigator may have access to the actual tires of the vehicle in question. In this instance, the wear and condition of the actual tire comes into play, and provides an accurate measurement and calculation without relying on a correction factor.

Any means for attaching the tire to the lower surface 22 of the sled body 20 may be used, so long as the tire sample 30 is removable. Hook and loop fasteners, clamps, screws, non-permanent glues, etc. or combinations thereof can be used to attach the tire sample 30 to the bottom surface of the sled body 20. The fastening means also should not make contact with the test surface S.

In the embodiment shown in FIG. 1, the front end 24 of the sled body 20 is provided with a hook 28 which passes through a hole 32 at one end of the tire sample 30 (see FIG. 2). The opposite, rear end 26 is provided with a hook and loop fastener (not shown), which mates with a fastener 34 on the tire sample 30. The underside 36 of the tire sample 30 is secured to the lower surface 22 of the sled body 20, such that the tire tread 38 faces the test surface S and is capable of making contact therewith, at least on a flat portion between the front and rear curved ends (24, 26).

FIG. 1 also shows optional guides 62 on either side of the sled to help position the tire sample 30. Although not strictly necessary, the guides 62 help align and maintain the alignment of the tire sample 30 consistent with the direction of the sled. Importantly, as depicted, the guides 62 do not extend to the test surface S where they would interfere with the measurement.

Methods of using the drag sled 10 are also contemplated herein. In particular, a method of calculating the speed of a vehicle based upon braking skid marks left by that vehicle, comprises employing a drag sled 10 having a tire sample 30 in contact with a test surface S, wherein the tire sample 30 is obtained from substantially the same brand and/or model tire, as the vehicle in question. It should be recognized that although the exact tire from the accident scene is preferred, it is not necessary. A tire, regardless of brand or model, of similar design can be used as a close approximation. In some embodiments, the method will employ a drag sled 10 having a tire sample 30 cut from the actual tire of the vehicle in question. In either case, the tangential force is measured by pulling the drag sled 10 across the test surface S. From the measured tangential force, the coefficient of friction may be calculated and used in traditional formulas, along with the length of the skid marks, for calculating speed therefrom.

Although the present invention has been described with reference to these exemplary embodiments, it is not limited thereto. Those skilled in the art will appreciate that numerous changes and modifications may be made to the preferred embodiments of the invention and that such changes and modifications may be made without departing from the true spirit of the invention. It is therefore intended that the appended claims be construed to cover all such equivalent variations as fall within the true spirit and scope of the invention.

What is claimed is:

1. A drag sled for calculating the coefficient of friction between a tire in question and a test surface, the drag sled comprising:
a sled body, having a curved front end and defining a lower surface; and
a tire sample, having a tread surface, wherein the tire sample is sized and configured to be removably affixed to the lower surface of the sled body such that the tread surface faces the test surface.

2. The drag sled of claim 1, wherein the tire sample is removably affixed to the lower surface of the sled body by one or more of hook and loop fasteners, hooks, screws, buttons, and non-permanent glue.

3. The drag sled of claim 1, wherein the tire sample is substantially similar to the tire in question.

4. The drag sled of claim 1, wherein the tire sample is the same brand and/or model as the tire in question.

5. The drag sled of claim 1, wherein the tire sample is derived from the actual tire in question.

6. A kit for evaluating coefficient of friction of a surface, the kit comprising:
a sled body, having a curved front end and defining a lower surface; and
a plurality of tire samples, each sized and configured to be removably affixed to the lower surface of the sled body, and each representing a different model of tire.

7. A method of calculating the speed of a vehicle based upon braking skid marks left by that vehicle, comprising:
employing a drag sled having a tire sample in contact with a test surface, wherein the tire sample is obtained from substantially the same brand and/or model tire, as the vehicle in question.

8. The method of claim 7, wherein the tire sample is derived from the actual tire in question.
